(19) United States
(12) Patent Application Publication
(10) Pub. No.: US 2012/0047094 A1
(43) Pub. Date: Feb. 23, 2012

(54) CALENDAR AND CALENDAR PRODUCTION METHODS

(76) Inventor: DAVID LANGTRY, New Westminster (CA)

(21) Appl. No.: 12/857,856

(22) Filed: Aug. 17, 2010

(51) Int. Cl. G06Q 90/00; G09D 3/00

(52) U.S. Cl. 705/500; 40/107

(57) ABSTRACT

A method of producing a calendar of a calendar year includes providing a photo contest having an entry period of time, accepting photographs entered into the photo contest by contestants during the entry period of time to establish a pool of photographs to be judged, and judging the photographs of the pool of photographs to produce photo contest winners comprising a calendar year photograph cover winner, and calendar month photograph cover winners. The method further includes providing a calendar including a calendar cover and a register of calendar days of calendar weeks of calendar months of a calendar year, the calendar cover incorporating the calendar year photograph cover winner, and the register incorporating the calendar month photograph cover winners each relating to one of the calendar months.

### FIELD OF THE INVENTION

This invention relates generally to the field of calendaring and, more particularly, to calendric devices for dividing time over extended periods, such as days, weeks, months or years, and for promotional purposes, and to calendar production methods.

### BACKGROUND OF THE INVENTION

A calendar is normally defined as any system or device for dividing time over extended periods, such as days, months, or years, and arranging such divisions in a definite order. A calendric system is essential for regulating the basic affairs of civil life and for reckoning time for religious observances and scientific purposes.

There are several standard units common to virtually all calendric systems. The day is the fundamental unit of computation in any calendar. It is to some extent a natural division of time, since it is based on the length of time it takes the Earth to rotate once on its axis; but its subdivision into a number of equal intervals of, for example, twenty four (24) hours is purely artificial.

The week is also an artificial division of time and cannot be correlating with any astronomical or natural phenomenon except insofar as it is a closed cycle of days. The seven-day week that is now universally used may have been derived from the mystical significance attached to the number seven. Support for this view may perhaps be derived from the use of the names of gods and goddesses for each of the days.

The month is a calendric period derived from lunation, the time interval in which the Moon completes a full cycle of its phases. This period, known as the synodic month, consists of 29.53059 days. As the earliest adopted of the longer calendar periods, it had significance in ancient religious observance.

The year is based on the length of time it takes the Earth to orbit the Sun. There are several ways to measure this period, but the most common is the tropical year, which is the interval between successive passages of the Sun through the vernal equinox. The year thus computed consists of 365.242199 mean solar days, i.e., 365 days 5 hours 48 minutes 46 seconds.

Unfortunately, the tropical year and the synodic month are incommensurable: 12 lunations come to 354.36706 days, almost 11 days less than a tropical year. In addition, neither the tropical year nor the synodic month is evenly divisible by the length of the day. Therefore, to compile or maintain any calendar that keeps in step with the Moon's phases or with the seasons, it is necessary to insert days at appropriate intervals. These extra days are known as intercalations. The most familiar example of an intercalation is the additional day given to February every fourth year, which is commonly referred to as leap year.

With the exception of the Muslim calendar and the traditional Hindu and Jewish calendars used primarily for religious purposes, the primary calendric system largely in use today is the Gregorian calendar. There are many forms of Gregorian calendars presently in use which incorporate a variety mechanical features suitable for aiding a user in easily adjusting the calendar from year to year, month to month, and/or from day to day. A feature common to known present calendric devices is that they normally operate only as a calendar. In this regard, many calendars that people use in the home, workplace and other venues, are uninteresting and limited in their utility thus becoming largely unnoticed if not infrequently or completely unused, thus necessitating certain improvements for enhancing the interest in, and utility of, calendars.

### SUMMARY OF THE INVENTION

According to the principle of the invention, a method of producing a calendar of a calendar year includes providing a photo contest having an entry period of time, accepting photographs entered into the photo contest by contestants during the entry period of time to establish a pool of photographs to be judged and the photographs each relating to a contestant, judging the photographs of the pool of photographs to produce photo contest winners including a calendar year photograph cover winner and calendar month photograph cover winners, and providing a calendar including a calendar cover and a register of calendar days of calendar weeks of calendar months of a calendar year, the calendar cover incorporating the calendar year photograph cover winner, and the register incorporating the calendar month photograph cover winners each relating to one of the calendar months. Further to the present method are the steps of providing a grand prize having a first value, and awarding the grand prize to the contestant relating to the calendar year photograph cover winner. In a particular embodiment, the method still further includes the steps of providing monthly prizes each having a second value lesser than the first value of the grand prize, and awarding one of the monthly prizes to each of the contestants relating to the calendar month photograph cover winners. In a further embodiment, the step of judging the photographs further includes judging the photographs of the pool of photographs to produce runner-up calendar month photograph winners, and the step of providing a calendar further includes providing the register incorporating at least one of the runner-up calendar month photograph winners with each of the calendar months. In conjunction with this latter embodiment, the method further specifies providing monthly runner-up prizes each having a third value lesser than the second value of each of the monthly prizes, and awarding one of the monthly runner-up prizes to each of the contestants relating to the runner-up calendar month photograph winners. According to the principle of the invention, the method still further specifies providing the calendar month photograph cover winners in a first size, and providing the runner-up calendar month photograph winners each in a second size lesser than the first size. To generate advertising revenue, a particular embodiment of the invention includes the steps of selling advertising space to advertisers, incorporating the advertising space in the calendar, such as in the register of the calendar, and incorporating advertisements of the advertisers in the advertising space. Preferably, the calendar is a printed calendar.

According to the principle of the invention, a method of producing a calendar of a calendar year includes a service provider issuing purchase receipts to customers, the purchase receipts each providing in writing an acknowledgement of a customer payment of a bill and a photo contest entry form to be filled out with identifying information, providing a photo contest having an entry period of time, accepting photographs entered into the photo contest by contestants during the entry period of time to establish a pool of photographs to be judged, the photographs each relating to a contestant and attached to one of the purchase receipts issued by the service provider with the photo contest entry form thereof filled out in writing with identifying information relating to the contestant, judging the photographs of the pool of photographs to produce photo contest winners including a calendar year photograph cover winner and calendar month photograph cover winners, and providing a calendar including a calendar cover and a register of calendar days of calendar weeks of calendar months of a calendar year, the calendar cover incorporating the calendar year photograph cover winner, and the register incorporating the calendar month photograph cover winners each relating to one of the calendar months. Further steps include providing a grand prize having a first value, using the identifying information of the purchase receipt attached to the calendar year photograph cover winner to identify the contestant relating thereto, and awarding the grand prize to the contestant identified by the identifying information of the purchase receipt attached to the calendar year photograph cover winner. In yet a further aspect of the invention, the method further includes providing monthly prizes each having a second value lesser than the first value of the grand prize, using the identifying information of the purchase receipts attached to the calendar month photograph cover winners to identify the contestants relating thereto, and awarding one of the monthly prizes to each of the contestants relating to the calendar month photograph cover winners. To generate advertising revenue, the invention further includes the steps of selling advertising space to advertisers, incorporating the advertising space in the calendar, such as in the register of the calendar, and incorporating advertisements of the advertisers in the advertising space. The calendar is preferably a printed calendar.

According to the principle of the invention, a method of producing a calendar of a calendar year includes a service provider issuing purchase receipts to customers, the purchase receipts each providing in writing an acknowledgement of a customer payment of a bill and a photo contest entry form to be filled out with identifying information, providing a photo contest having an entry period of time, accepting photographs entered into the photo contest by contestants during the entry period of time to establish a pool of photographs to be judged, the photographs each relating to a contestant and attached to one of the purchase receipts issued by the service provider with the photo contest entry form relating thereto filled out in writing with identifying information relating to the contestant, judging the photographs of the pool of photographs to produce photo contest winners including a calendar year photograph cover winner, calendar month photograph cover winners, and runner-up calendar month photograph winners, and providing a calendar including a calendar cover and a register of calendar days of calendar weeks of calendar months of a calendar year, the calendar cover incorporating the calendar year photograph cover winner, the register incorporating the calendar month photograph cover winners each relating to one of the calendar months, and each of the calendar months incorporating at least one of the runner-up calendar month photograph winners. The method further specifies providing the calendar month photograph cover winners in a first size, and providing the runner-up calendar month photograph winners each in a second size lesser than the first size. The method still further includes the steps of providing a grand prize having a first value, using the identifying information of the purchase receipt attached to the calendar year photograph cover winner to identify the contestant relating thereto, and awarding the grand prize to the contestant identified by the identifying information of the purchase receipt attached to the calendar year photograph cover winner. Still further method steps include providing monthly prizes each having a second value lesser than the first value of the grand prize, using the identifying information of the purchase receipts attached to the calendar month photograph cover winners to identify the contestants relating thereto, and awarding one of the monthly prizes to each of the contestants relating to the calendar month photograph cover winners. According to the principle of the invention, further to the present method are the steps of providing monthly runner-up prizes each having a third value lesser than the second value of each of the monthly prizes, using the identifying information of the purchase receipts attached to the runner-up calendar month photograph winners to identify the contestants relating thereto, and awarding one of the monthly runner-up prizes to each of the contestants relating to the runner-up calendar month photograph winners. To generate advertising revenue, additional method steps include selling advertising space to advertisers, incorporating the advertising space in the calendar, such as in the register of the calendar, and incorporating advertisements of the advertisers in the advertising space. The calendar is preferably a printed calendar.

### BRIEF DESCRIPTION OF THE DRAWINGS

Referring to the drawings:

FIGS. 1A-1D are flowcharts representing steps of a method of producing a calendar in accordance with the principle of the invention;

FIG. 2 is a perspective view of a customer walking a pet on a leash toward a pet store in conjunction with a method of producing a calendar according to the principle of the invention;

FIG. 3 is a generalized perspective view of point-of-purpose counter located within the interior of the pet store of FIG. 2 illustrating a clerk handing the customer of FIG. 2 a receipt in payment of a bill for a bag of pet food located in a shopping cart all in conjunction with a method of producing a calendar in accordance with the principle of the invention;

FIG. 4 is a front view of the receipt of FIG. 3 illustrating bill and payment details;

FIG. 5 is a back view of the receipt of FIG. 3 illustrating an entry form in conjunction with a method of producing a calendar in accordance with the principle of the invention;

FIG. 6 is a perspective view of a photograph attached to the receipt of FIG. 3 shown as it would appear attached to a photograph relating to the customer of FIGS. 2 and 3, the receipt and the attached photograph shown being applied to an entry box all in conjunction with a method of producing a calendar in accordance with the principle of the invention;

FIG. 7 is a perspective view of a calendar constructed and arranged in according with a method of producing a calendar according to the principle of the invention, the calendar including a calendar cover and a register of calendar days of calendar weeks of calendar months of a calendar year; and

FIG. 8 illustrates the calendar of FIG. 7 shown as it would appear open illustrating a register of calendar days of calendar weeks of a calendar month of a calendar year.

### DETAILED DESCRIPTION

A method of producing a calendar of a calendar year is disclosed, which, in general, includes providing a photo contest having an entry period of time, contestants entering photographs into the photo contest during the entry period of time, accepting photographs entered into the photo contest by contestants during the entry period of time to establish a pool of photographs to be judged and the photographs each relating to a contestant, judging the photographs of the pool of photographs to produce photo contest winners consisting of selected winning photographs of the pool of photographs, and providing a calendar, including a calendar cover and a register of calendar days of calendar weeks of calendar months of a calendar year, incorporating the photo contest winners, namely, the winning photographs. The method is preferably carried out by and between, on the one hand, a service provider, such as a retailer of products or services or both products and services, and, on the other hand, the contestants, which preferably consist of customers of the service provider. As the calendar produced by the method according to this specification incorporates winning photographs each relating to one of the contestants, the calendar is uniquely interesting to contestants of the photo contest, provides an acute impetus among potential contestants to become customers of the service provider in order to participate in the photo contest conducted by the service provider, and provides a unique platform for promotional and advertising purposes of the service provider.

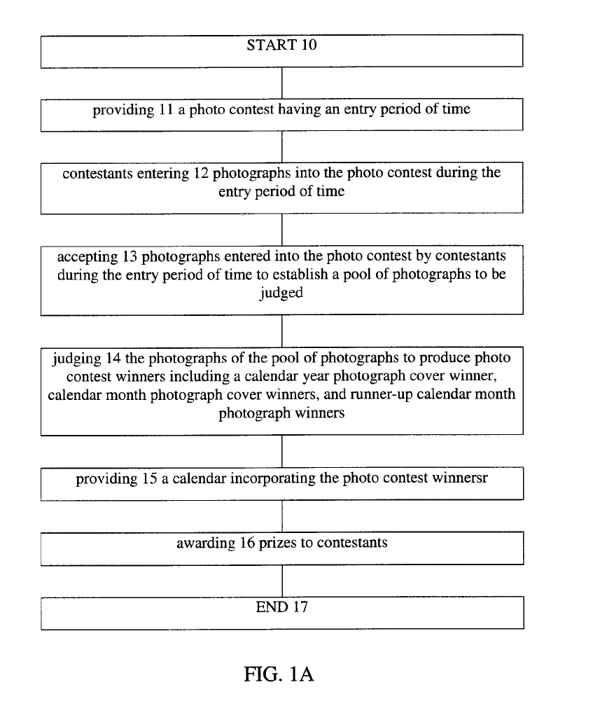

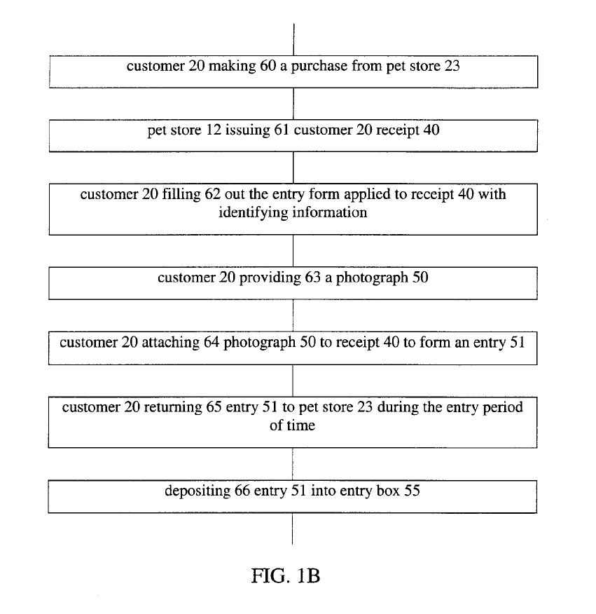

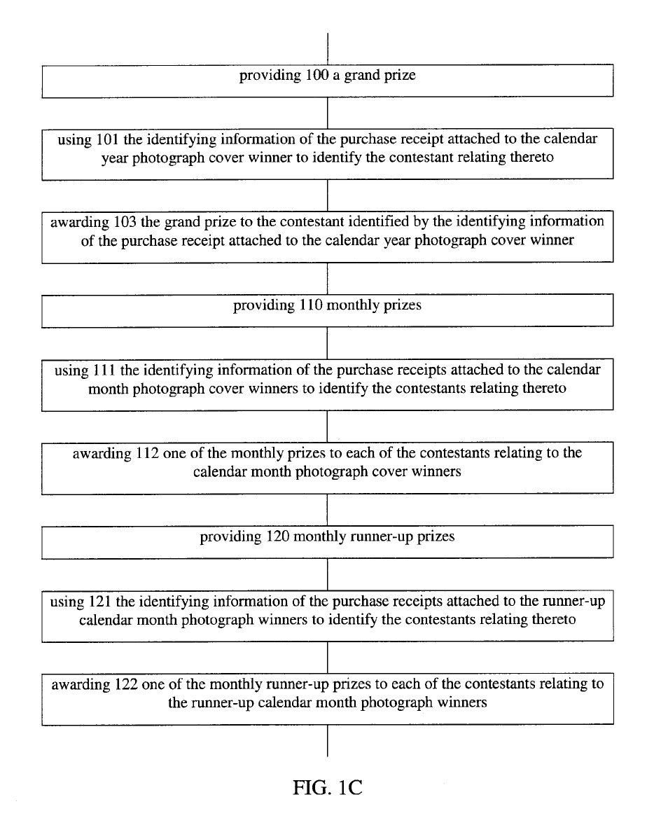

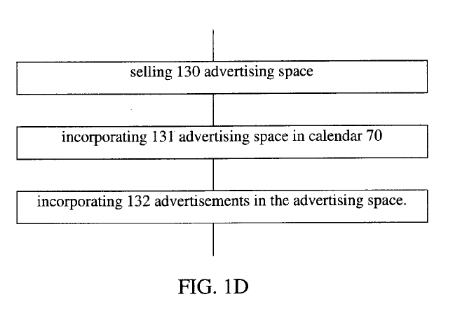

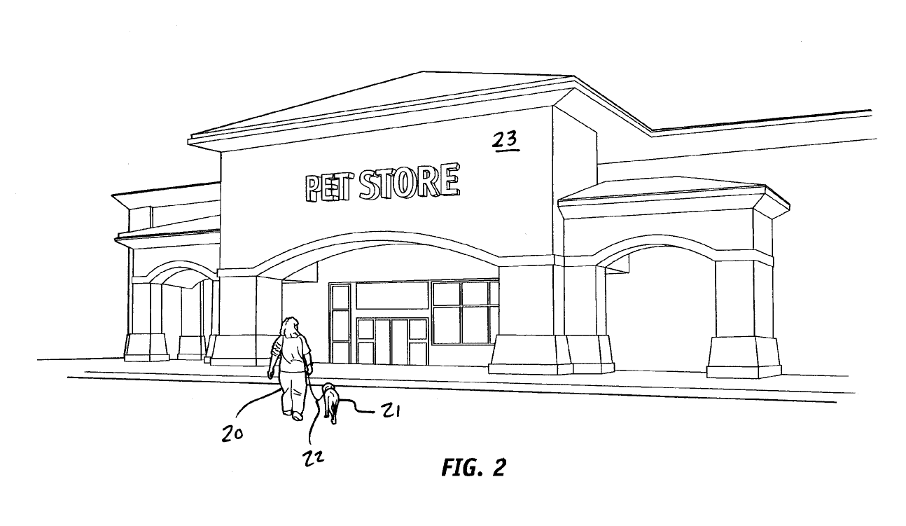

Turning now to the drawings, in which like reference characters indicate corresponding elements throughout the several views, FIGS. 1A-1D are flowcharts representing steps of a method of producing a calendar in accordance with the principle of the invention. With specific reference to FIG. 1A, the method, in general, starts at 10 with step 11 of providing a photo contest having an entry period of time, step 12 of contestants entering photographs into the photo contest during the entry period of time, step 13 of accepting photographs entered into the photo contest by contestants during the entry period of time to establish a pool of photographs to be judged, step 14 of judging the photographs of the pool of photographs to produce photo contest winners consisting of winning photographs of the pool of photographs, step 15 of providing a calendar incorporating the photo contest winners, and step 16 of awarding prizes to the contestants relating to the photo contest winners, which ends the method at step 17. The method generally specified and set forth in FIG. 1 is preferably carried out by and between, on the one hand, a service provider and, on the other hand, contestants consisting of customers of the service provider, and the photographs entered into the photo contest are original photographs originally authored by or otherwise taken by the contestants of the photo contest. Steps 11 and 13-16 are carried out by the service provider, and step 11 is facilitated by a combination of steps carried not only by contestants but also by the service provider, the details of which are set forth below with particularity. In accordance with this disclosure, the service provider is a pet store or pet shop, namely, a retail business relating to domestic pets that sells different kinds of domestic pets, pet food, supplies, and accessories, and, if applicable, related services such as pet grooming services, pet training services, pet education services, etc. Consistent with this generalized method framework, further details of the method, the photographs entered into the photo contest, and the calendar produced by the method will now be discussed in connection with FIGS. 2-7.

As the method according to the principle of the invention is preferably carried out by a pet store, the method according to the invention is carried out by and between a pet store and customers of the pet store who make product and/or service purchases from the pet store. For the purposes of illustration and reference, FIG. 2 depicts a female customer 20 walking her pet 21 on a leash 22 toward a pet store 23 for the purpose of making a purchase from pet store 23 in order to participate in a photo contest conducted by pet store 23 according to the method set forth in this specification. Pet store 23 is a typical pet store consisting of a retail business that sells different kinds of animals, pet food, supplies, and accessories, and, if applicable, related services, such as pet grooming services, pet training services, pet education services, etc. Pet store 23 is exemplary of a customary and well-known pet store, such as a PETCO® pet store, a PETSMART® pet store, or the like. And so customer 20 enters pet store 23 for the purpose of purchasing one or more products and/or services for her pet 21. In the present example, the purpose of customer 20 visiting pet store 23 is to purchase a product, namely, pet food for pet 21. In this example, pet 21 is a dog, and the purpose of customer 20 visiting pet store 23 is to purchase dog food for pet 21.

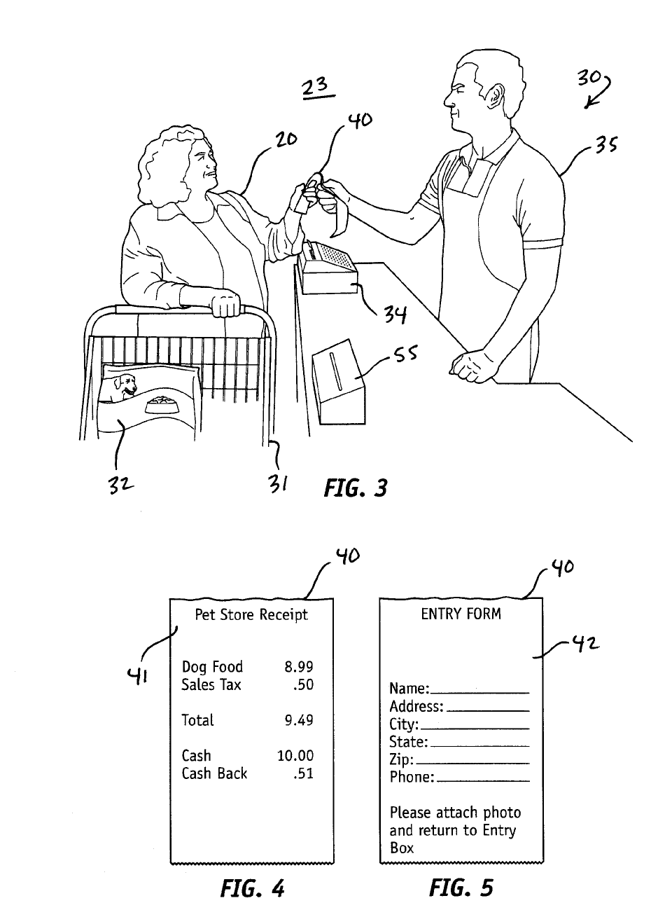

Accordingly, customer 20 and pet 21 enter pet store 23, customer 20 selects dog food from the inventory in pet store 23, and then proceeds to the checkout counter or point-of-purpose counter to purchase her pet food in a normal and customary manner. To this end, FIG. 3 is a generalized perspective view of a checkout or point purchase counter 30 located within the interior of pet store 23. Customer 20 is shown wielding a shopping cart 31 holding a bag of dog food 32 she has selected to be purchased. Counter 30 is typical and common, and is manned by a clerk 35 in the normal manner and is furnished with a cash register 34. Cash register 34 is a conventionally structured mechanical or electronic device useful for calculating and recording sales transactions, and which is configured to print sales receipts.

The cost of dog food 32 to be purchased by customer 20 from pet store 23 in the present example is $8.99. Clerk 35 uses cash register 34 in the conventional manner to calculate the total cost or total sales price of dog food 32, which, for the purposes of example, comes to a total of $9.49 inclusive of an applicable sales tax of $0.50, which is chosen merely as a matter of example of a typical sales tax of a typical sales transaction. The calculation of the total sales price of $9.49 to purchase dog food 32 represents a bill for dog food 32, which is normally displayed to customer 20 on cash register 34 or an associated display, or perhaps verbally by clerk 35, which customer 20 pays in a conventional manner, such as by cash, check, debit card, or credit card. Having paid for dog food 32 in a normal and customary manner, clerk 35 processes the payment with cash register 34, prints a purchase or sales receipt 40 with cash register 34, and then issues receipt 40 to customer 20 simply by handing receipt 40 to customer 20 as shown in FIG. 3, thus completing the sales transaction. According to the principle of the invention, receipt 40 is used by customer 20 to make an entry into the photo contest conducted by pet store 23.

Receipt 40 is a written acknowledgement of pet store 23 having received a specified amount of money in payment of a bill for a product or service, which, in the present embodiment, is a product consisting of dog food 32. Receipt 40 is a document, formed of paper or other like or similar substrate as is to be expected with a conventional receipt generated by a conventionally structured cash register, such as cash register 34, and is furnished not only with details memorializing a customer payment of a bill but also with an entry form for the photo contest provided by pet store 23. Cash register 34 is conventionally programmed or otherwise configured to incorporate an entry form on receipt 40. The entry form incorporated in receipt 40 is the gateway for customer 20 to enter the photo contest provided by pet store 23.

Receipt 40 has a front face 41, as shown in FIG. 4, and an opposed back face 42, as shown in FIG. 5. Front face 41 is printed with indicia memorializing the sales transaction or customer purchase specified above, and back face 42 is printed with indicia forming an entry form, according to the principle of the invention. And so receipt 40 is a useful component of the invention in that it not only memorializes a sales transaction, but also incorporates an entry form to be used by the customer that was issued receipt 40 to make an entry into the photo contest conducted by pet store 23. If desired, the details of the sales transaction and the entry form may be incorporated on one face of receipt 40.

FIG. 4 illustrates front face 41 formed with applied indicia in the form of printing detailing the sales transaction between customer 20 and pet store 23, including the net price of dog food 32 of $8.99, the applicable sales tax of $0.50 as calculated by cash register 34, the total sales price of dog food 32 of $9.49 as calculated by cash register 34, the amount of cash furnished by customer 20 in payment with cash of the total sales price of $9.49 representing the bill to customer 20 for pet food 32, and the change or cash back provided to customer 20 by clerk 35 in the amount of $0.51. FIG. 5, in turn, illustrates back face 42 formed with applied indicia in the form of printing forming an entry form for the photo contest conducted by pet store 23. The entry form includes, simply, writings related to identifying information of the customer to receipt 40 including, as a matter of example, writings of “name”, “address”, and “phone” associated with blank spaces to be filled in with personal or identifying information or particulars of the customer before it is turned back in to pet store 23, accompanied by a photograph, for processing in the photo contest. The entry form also includes writings providing written instructions to attach a photo to receipt 40 and return them both to pet store 23 by depositing them into an entry box for making an entry of the photograph into the photo contest conducted by pet store 23.

Referencing FIG. 1A, step 11 specifies providing a photo contest having an entry period of time, step 12 specifies contestants entering photographs into the photo contest during the entry period of time, and step 13 specifies accepting photographs entered into the photo contest by contestants during the entry period of time. Steps 11 and 13 are, of course, carried out by pet store 23. With respect to step 11, the entry period of time has a beginning and an end ending, and this is common among conventional photo contests. The entry period of time during which step 13 of accepting is carried out takes place before step 14 of judging in preparation for providing the calendar in step 15. Steps 14 and 15 are, as indicated above, carried out by pet store 23. Preferably, the entry period of time is defined during a calendar year that precedes a succeeding or a next calendar year to be calendared in a calendar produced according to the invention.

As a matter of example, the entry period of time extends from January 1 to June 30 of a calendar year that precedes a succeeding or a next calendar year to be calendared. As a matter of example, the calendar year to be calendared according to the invention is the year 2010, the entry period of time of a photo contest conducted according to the invention begins on Jan. 1, 2009, and ends on Jun. 30, 2009. Although the preferred entry period of time of the method according to the invention is between January 1 and June 30 of the year before the next year to be calendared, other entry periods of time can be utilized, if so desired, without departing from the invention. As a matter of example of different entry periods of time, the entry period of time can be defined, in whole or in part, during the one or two calendar years that precede the calendar year to be calendared. And so for a 2010 calendar produced according to the method set forth in this disclosure, the entry period of time can be defined during the 2008 calendar year, during the 2009 calendar year, or during both the 2008 and 2009 calendar years.

The photographs entered into the photo contest conducted by pet store 23 are original photographs originally authored or otherwise taken by contestants of the photo contest, such as customer 20 in the present example. This is a typical requirement of conventional photo contests, and the photo contest according to this disclosure is no different from conventional photo contests in this specific regard. According to the principle of the invention, the subject matter of the photographs entered into the photo contest preferably relates to the field of the service provider. As the service provider in the present example is a pet store servicing customers that own domestic pets, the subject matter of the photographs entered into the photo contest according to the invention is the actual domestic pets owned by the customers of pet store 23. The provision of the specified subject matter of the photographs as herein specifically described is a requirement of the photo contest as set by the service provider, which, in the present embodiment, is pet store 23. In this vein, making an entry of a photograph into the photo contest according to this disclosure in conjunction with step 12 of the method denoted generally in FIG. 1A will now be discussed in connection with customer 20, with the understanding that the ensuing discussion applies to each photograph entered in to the photo contest by each customer during the entry period of time of the photo contest according the principle of the invention.

As explained herein, the subject matter of the photographs entered into the photo contest preferably relates to the field of the service provider, the service provider in the present example is a pet store servicing customers that own domestic pets, and the subject matter of the photographs entered into the photo contest according to the invention is, accordingly, the actual domestic pets owned by the customers of pet store 23. The calendar production method according to the principle of the invention may be carried out by any service provider regardless of the field. As a matter of example, the service provider may be a vehicle repair shop, such that the subject matter of related photographs entered into a photo contest carried out by the vehicle repair shop could be the actual vehicles of customers of the vehicle repair shop. In another embodiment, the service provider may be a fishing guide service, such that the subject matter of photographs entered into a photo contest carried out by the fishing guide service could be the actual fish caught by customers of the vehicle repair shop.

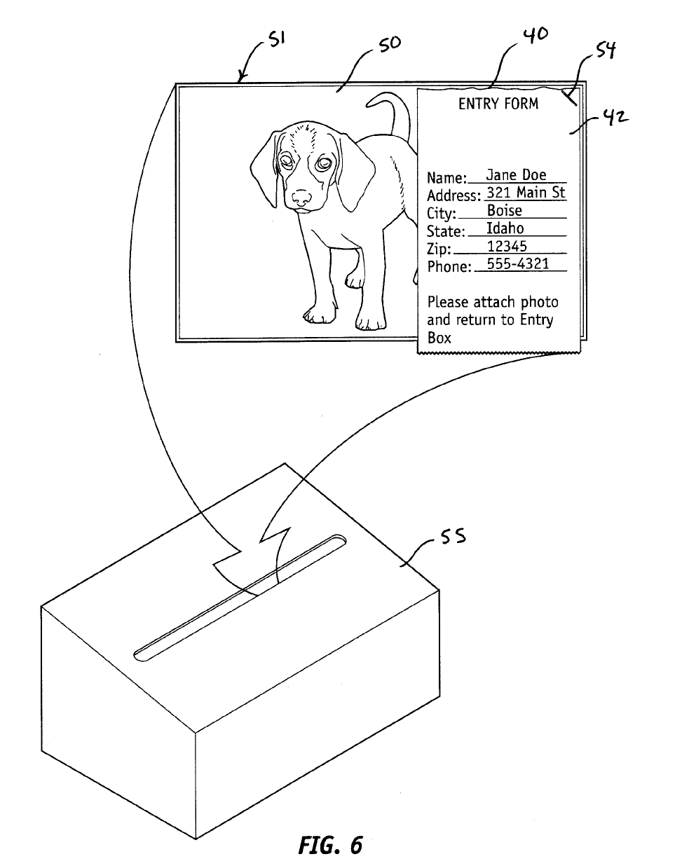

After having made a purchase from pet store 23 and having received receipt 40, customer 20 uses receipt 40 to enter a photograph into the photo contest provided by pet store 23 during the entry period of time specified in step 11 denoted in FIG. 1A. In the present example the purchase made by customer 20 is of a single product, and it is to be understood that the purchase related to an issued receipt may be of one or more products and/or services of pet store 23. Making an entry into the photo contest according to step 12 involves, as illustrated in FIG. 1B, various method steps including customer 20 making a purchase from pet store 23 at step 60, pet store 12 issuing customer 20 receipt 40 to customer 20 at step 61 memorializing the customer purchase as discussed above and which incorporates the entry form, customer 20 filling out the entry form applied to back face 42 of receipt 40 at step 62 with identifying information corresponding to the “name”, “address”, and “phone” components of the entry form, customer 20 providing a photograph 50 at step 63, customer 20 attaching photograph 50 to receipt 40 at step 64 to form an entry 51 shown in FIG. 6, and customer 20 returning entry 48 to pet store 23 at step 65 during the entry period of time, which, in this example, coincides with customer 20 purchase previously discussed. By following this entry procedure consisting of sub-steps of step 12 denoted in FIG. 1A, the step of pet store 23 accepting photographs according to step 13 is accomplished.

Entry 51 is depicted in FIG. 6. Referencing FIG. 6, photograph 50 is an original photograph originally authored or otherwise taken by customer 20 of her pet 21, the entry form is filled out with identifying information related to customer 20 including the name, address, and phone of customer 20 as shown, receipt 40 is attached to photograph 50 with a staple 54, and entry 51, formed by photograph 50 and attached receipt 40 with the entry form thereof filled out with the corresponding identifying information of customer 20. With entry 51 so formed, entry 51 is then returned to pet store 23 by, as denoted in FIG. 1B, depositing entry 51 into an entry box 55 of pet store 23 shown in FIGS. 3 and 6. FIG. 3 shows entry box 55 positioned near cash register 34 at counter 30 as shown in FIG. 3 as a matter of illustration and reference.

Although staple 54 is used in the present example to attach receipt 40 to photograph 50, a paper clip or other mechanical fastener may be used. To attach receipt 40 to photograph 50, both may be placed in sealed envelope if so desired. Although returning entries to pet store 23 preferably involves depositing entries into entry box 55, entries can be returned to pet store 23 in other ways. For instance, entries may be returned to pet store 23 by mailing in an envelope, entries may be digitized and returned to pet store 23 by emailing to a designated email address of pet store, etc. By emailing the receipt and a photograph, the receipt is considered attached to the photograph.

Each entry 51 is made and accepted according to the above description in connection with steps 12 and 13 in FIG. 1A, and sub-steps 60-66 specified in FIG. 1B. During the entry period of time, a potentially large number of entries are made and accepted in connection with steps 12 and 13 in FIG. 1A and sub-steps 60-66 in FIG. 1B to establish a pool of photographs to be judged, in accordance with the principle of the invention. During the entry period of time, the entries are periodically retrieved from entry box 55 by authorized personnel of pet store 23. Pet store 23 incorporates one entry box in the present example, and it may incorporate numerous entry boxes if so desired. And so at the ending of the entry period of time, the step of accepting denoted at 13 in FIG. 1 ends and the pool of photographs to be judged is established, which then leads to step 14 of judging the photographs of the pool of photographs for the purpose of producing photo contest winners, according to the principle of the invention.

Each photograph of the pool of photographs relates to an entry and to a contestant. And so after the entry period of time has ended and the pool of photographs to be judged is established, the method next provides judging the photographs of the pool of photographs at step 14 in FIG. 1A to produce photo contest winners, namely, a calendar year photograph cover winner, calendar month photograph cover winners, and runner-up calendar month photograph winners.

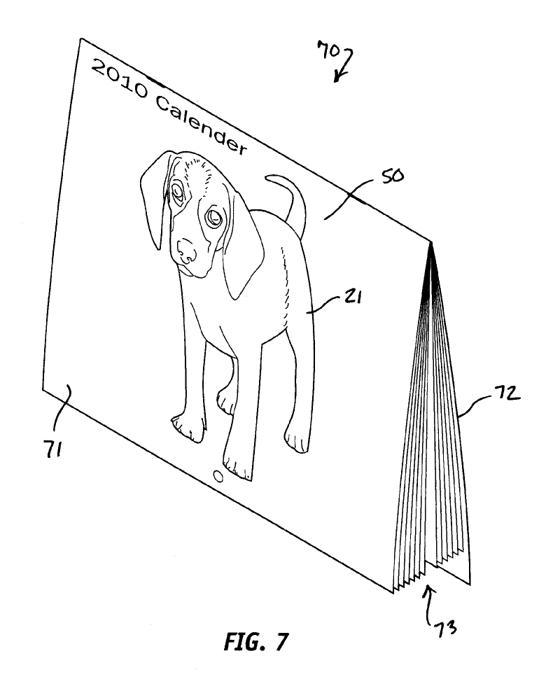

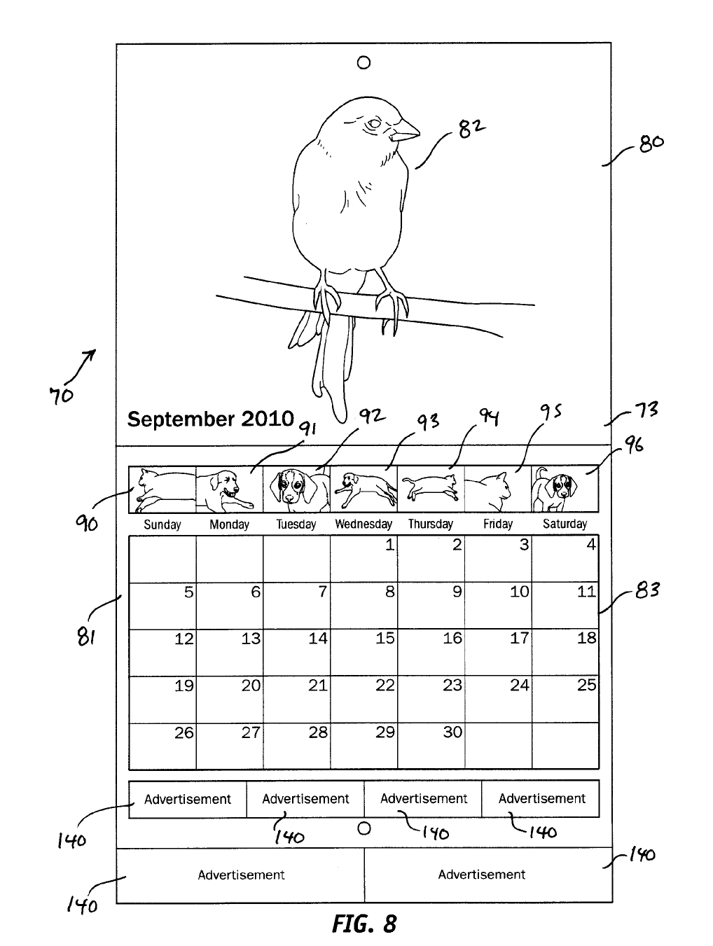

Step 14 of judging is carried out by pet store 23, such as by authorized personnel or judges of pet store 23 or perhaps by independent judges hired or commissioned by pet store. The judging of the photographs is carried out in a conventional manner like that of conventional photo contests. As a matter of example of typical judging, the photographs are examined for their overall execution or craft, including the sharpness of the images, the quality of the details, the contrast and tone, the lighting and color, and the overall composition of the photographs. The photographs are scored based on the above criteria, and the scores are tallied to produce the winners, namely, a calendar year photograph cover winner, calendar month photograph cover winners, and runner-up calendar month photograph winners. With the designated photograph winners established, step 15 of providing a calendar 70 incorporating the calendar year photograph cover winner, the calendar month photograph cover winners, and the runner-up calendar month photograph winners is then carried out by pet store 23, which is shown in FIGS. 7 and 8.

Calendar 70 shown in FIG. 7 is a device that divides time over an extended period, namely, the days, weeks, and months of a calendar year. Calendar 70 is a printed calendar, formed of thick paper or card stock or the like, is designed to be hung and displayed on a vertical wall, and is printed with a register of calendar days of calendar weeks of calendar months of the selected calendar year, and is further printed with the calendar year photograph cover winner, the calendar month photograph cover winners, and the runner-up calendar month photograph winners. Calendar 70 is printed with the register and with the winning photographs consisting of the results of the photo contest with entirely conventional and well-known calendar printing techniques.

Calendar 70 is formed by a series of bound, folded pages, and in use is able to be hung on a vertical surface or wall with a nail, tack, or the like to display the various calendared months of the calendar year calendared by calendar 70, as with a conventional folded calendar. Calendar 70 is exemplary of a folded calendar and includes a opposed covers 71 and 72, and a series of bound and folded pages 73 formed therebetween forming a register of calendar days of calendar weeks of calendar months of a calendar year to be calendared. Cover 71 is the main, front, or calendar cover of calendar 70, and cover 72 is the back cover of calendar 70. Cover 71 is printed with and thus incorporates the calendar year photograph cover winner, the register formed by pages 73 is printed with and thus incorporates the calendar month photograph cover winners each relating to one of the calendar months, and each of the calendar months of the register formed by pages 73 is printed with and incorporates at least one of the runner-up calendar month photograph winners. The calendar year photograph cover winner is the top winner of the photo contest, the calendar month photograph cover winners stand on equal footing and are each considered a runner-up winner to the calendar year photograph winner, and the runner-up calendar month photograph winners stand on equal footing and are each considered a runner-up winner to each of the calendar month photograph cover winners. With twelve months in a calendar year, there are twelve calendar month photograph cover winners produced by step 15 of judging identified in FIG. 1A. As a matter of example and preference, there are a total of eighty-four runner-up calendar month winners, and each calendar month of calendar 70 incorporates seven of the eighty-four runner-up calendar month winners.

As the calendar year photograph cover winner is the top winner of the photo contest, it is printed on front cover 71 of calendar 70 as shown in FIG. 7 and is thus the most prominently displayed photographs of all of the winning photographs of the photo contest. In the present example, the calendar year cover photograph winner is customer 20 photograph 50 as shown in FIG. 7. Photograph 50 formed in front cover 71 has a size, which is large and prominently displayed on front cover 71.

For the purpose of illustration and reference, calendar 70 calendars the calendar year 2010 as labeled on front cover 71 as depicted in FIG. 7. Calendar year 2010, like any calendar year, incorporates the twelve customary months, namely, January, February, March, April, May, June, July, August, September, October, November, and December. These calendar months and the associated days and weeks are printed on pages 73 forming the register of calendar 70. Although each calendar month of calendar 70 relates to the specific days and weeks of a particular month, the calendar months of calendar 70 are identical in form and format, and only one calendar month will be described in detail, with the understanding that the ensuing of one calendar month of calendar 70 applies to each calendar month of calendar 70.

In FIG. 8 calendar 70 is shown unfolded illustrating an unfolded page 73 depicting calendar month September 2010. Page 73 is unfolded and divided at a central fold of page 73 forming in page 73 a top part or section 80 of page 73 and an opposed bottom part or section 81 of page 73, which are substantially coextensive in the present embodiment. Top section 80 relates to bottom section 81. Top section 80 is a monthly cover of the corresponding month registered at bottom section 81. Top section 80 of page 73 calendaring the September 2010 calendar month is printed with one of the twelve monthly photograph cover winners denoted at 82 provided by step 14 of judging denoted in FIG. 1A. Photograph 82 formed in top section 80 forming the monthly cover of the corresponding month has a size, which is large and prominently displayed.

Bottom section 81 of page 73 calendaring the September 2010 calendar month is printed with a register 83 of the days and weeks of the designated calendar month, namely, calendar month September 2010. The register formed in bottom section 81 is entirely conventional and consists of markings in the form of indicia to denote the days of and weeks of calendar month September 2010. The markings applied to bottom section 81 consist of a plurality of vertical columns each generally corresponding to a day of the week and designated respectively as Sunday, Monday, Tuesday, Wednesday, Thursday, Friday and Saturday, respectively. Still further included are a plurality of horizontal rows which intersect the vertical columns and each generally corresponding to a week of the calendared month, of which there are generally four. Register 83 is entirely conventional, and may be provided in other forms suitable to provide an appropriate register of the days and weeks of the specified calendar month.

Bottom section 81 of page 73 calendaring the September 2010 calendar month is printed with seven runner-up monthly photograph winners of the eighty-four runner-up calendar photograph winners provided by step 14 of judging denoted in FIG. 1A, which seven runner-up monthly photograph winners are denoted in FIGS. 8 at 90, 91, 92, 93, 94, 95, and 96, respectively. Photographs 90, 91, 92, 93, 94, 95, and 96 formed in bottom section 81 each have a size that is substantially smaller than the size of not only photograph 82, namely, the calendar month photograph cover winner of page 73 relating to the September 2010 calendar month, but also photograph 50 that, as seen in FIG. 7, is the calendar year photograph cover winner of calendar 70. In the embodiment of FIG. 8, photographs 90-96 are equal in size and shape, and are arranged in a row over register 83, and may be arranged in other ways as may be desired without departing from the invention.

In the embodiment of FIG. 8, bottom section 81 of page 73 calendaring the September 2010 calendar month incorporates seven photographs 90-96 each constituting a runner-up calendar month photograph winner, and bottom section 81 may incorporate less or more such photographs as may be desired. In a particular embodiment, bottom section 81 of page 73 calendaring the September 2010 calendar month may incorporate just one photograph constituting one of the runner-up calendar month photograph winners, with the remaining photographs constituting the runner-up calendar month photograph winners spread out amongst the remaining pages 73 of calendar 70 calendaring the remaining calendar months of the designated calendar year. In the preferred embodiment, eighty-four runner-up calendar month photograph winners are provided from step 14 of judging, and less or more can be provided if so desired. Regardless of the total number of runner-up calendar month photograph winners, each calendar month calendared by the register of calendar 70 may incorporate any desired number of runner-up monthly photograph cover winners, including just one if so desired.

Calendar 70 is thus uniquely formed by the method according to the invention as set forth in this specification. It is to be again emphasized that because calendar 70 produced by the method according to this specification incorporates winning photographs each relating to one of the contestants of the photo contest carried out by pet store 23, calendar 70 is uniquely interesting to the contestants of the photo contest, provides an acute impetus among potential contestants to become customers of pet store 23 in order to participate in the photo contest conducted by pet store 23, and, moreover provides a unique platform for promotional and advertising purposes of pet store.

To further enhance the calendar production method according to the invention, prizes may be provided and awarded to the contestants of the winning photographs of the photo contest, and advertising by paid advertisers may be incorporated into calendar 70. With regard to awarding prizes, the method specified in FIG. 1A includes step 16 of awarding prizes to the contestants relating to the photo contest winners. Step 16 is carried out by pet store 23 in a series of sub-steps set forth with particularity in FIG. 1C, which include step 100 of providing a grand prize, step 101 of using the identifying information of the purchase receipt attached to the calendar year photograph cover winner to identify the contestant relating thereto, and step 102 of awarding the grand prize to the contestant identified by the identifying information of the purchase receipt attached to the calendar year photograph cover winner. With respect to the calendar month photograph cover winners, the method relating to awarding prizes includes step 110 of providing monthly prizes, step 111 of using the identifying information of the purchase receipts attached to the calendar month photograph cover winners to identify the contestants relating thereto, and step 112 of awarding one of the monthly prizes to each of the contestants relating to the calendar month photograph cover winners. With respect to the runner-up calendar month photograph winners, the method relating to awarding prizes still further includes step 120 of providing monthly runner-up prizes, step 121 of using the identifying information of the purchase receipts attached to the runner-up calendar month photograph winners to identify the contestants relating thereto, and step 122 of awarding one of the monthly runner-up prizes to each of the contestants relating to the runner-up calendar month photograph winners. Awarding the various prizes to the various contestants related to the photo contest winners is carried out conventionally according to well-established procedures utilized in other forms of contests that award prizes to contestants, further details of which will readily occur to the skilled artisan.

The grand prize has a value, the monthly prizes each have a value, and the monthly runner-up prizes each have a value. Preferably, the value of the grand prize is greater than the value of each of the monthly prizes, and the value of each monthly prize is greater than that of each of the runner-up monthly prizes. As a matter of example, the grand prize is a prize of substantial value, such as a home, a yacht, a substantial monetary award, an exotic or luxury vehicle, or the like. Having a value lesser than that of the grand prize, each of the monthly prizes consist of, as a matter of example, a motorcycle, a water-ski boat, an averagely-prized car or truck, a vacation package, an all-terrain vehicle, free products and/or services provided by pet store 23, or other prize having a value less than the value of the grand prize. Having a value lesser than that of each of the monthly prizes, each of the runner-up monthly prizes consist of, as a matter of example, tickets to a concert, tickets to a professional sporting event, a set of golf clubs, camping gear, a kayak, cookware, a piece of furniture, or other prize having a value less than that of each of the monthly prizes. The provision of awarding prizes according to step 16 in FIG. 1A and the sub-steps specified in FIG. 1C provides yet another motivating factor among potential contestants to become customers of pet store 23 in order to participate in the photo contest conducted by pet store 23.

The aforementioned prizes are preferably provided by pet store 23 and paid for by revenue generated not only by customer sales and the sale of calendars but also by advertising revenue generated by calendar 70, the details of which are discussed below. Alternatively, the aforementioned prizes may be furnished by sponsors of pet store 23 and the calendars produced by the method set forth in this specification, such as home builders, vehicle manufacturers, vehicle dealers, banks, etc.

After calendar 70 is produced according to the method set forth with particularity throughout this specification, a substantial inventory of calendars each being a copy of calendar 70 is made, which inventory of such calendars are either given away by pet store 23 to customers of pet store 23, contestants of the photo contest conducted by pet store 23, and others free of charge, or sold to customers of pet store 23, contestants of the photo contest conducted by pet store 23, and others for a specified price. As a matter of pet store 23 generating revenue, it is preferred that pet store 23 sell the inventory of calendars for a predetermined price. To further generate revenue, the method of producing calendar 70 may further include various method steps to incorporate paid advertising by others in calendar 70, and various method steps relating to this aspect of the invention are set forth in FIG. 1D.

The method steps set forth in FIG. 1D are preferably carried out in the general method set forth in FIG. 1A before and during step 15 of providing calendar 70. To this end, FIG. 1D specifies step 130 of selling advertising space to advertisers, step 131 of incorporating advertising space in calendar 70, and step 132 of incorporating advertisements of the advertisers in the advertising space formed in calendar 70. The advertising space is offered for sale to potential advertisers by pet store 23 for pricing specified by pet store 23, sold advertising space is incorporated into calendar 70, and calendar 70 is printed with the advertisements in the advertising space sold by pet store 23 to selected advertisers. The advertising space and the advertisements incorporated therein can be formed at any selected locations of calendar 70, including front cover 71, back cover 72, and/or any of pages 73 forming the register of the calendar months of the calendar year calendared by calendar 70.

As a matter of example, FIG. 8 illustrates advertising spaces 140 formed in bottom section 81 of page 73 calendaring the September 2010 calendar month, and also an extension back 72 of calendar 70 extending below page 73. Advertising spaces 140 each incorporate an advertisement as simply and generally indicated by the writing “advertisement” provided in each advertising space 140, and relate to and promote the goods and/or services of corresponding advertisers. Advertising spaces 140 formed in page 73 calendaring the September 2010 calendar month of the calendar year calendared by calendar 70 are arranged in a row under register 83, and may be arranged in other ways as may be desired without departing from the invention. Any number of advertising spaces 140 incorporating advertising may be incorporated into calendar 70, and may be incorporated anywhere along the extent of calendar 70, including front cover 71, back cover 72, and any of pages 73 calendaring the calendar months of the calendar year calendared by calendar 70. Because calendar 70 produced by the method according to this specification incorporates winning photographs each relating to one of the contestants of the photo contest carried out by pet store 23 and is thus is uniquely interesting to a potentially large number of contestants of the photo contest, calendar 70 provides an excellent platform for the advertisements of others, in accordance with the principle of the invention. Furthermore, because each month of calendar 70 is displayed for one month in the use of calendar 70 through the calendar year calendared by calendar 70, the advertisements incorporated with each calendar month are displayed for a prolonged period of time providing a potent advertising platform.

The present invention is described above with reference to a preferred embodiment. However, those skilled in the art will recognize that changes and modifications may be made in the described embodiment without departing from the nature and scope of the present invention. For instance, in structure calendar 70 is exemplary of a folded calendar and is a physical device. A calendar constructed and arranged according to the method specified in this disclosure can be provided in other physical arrangements, such as a monthly tear-away calendar, or other selected form of physical calendar that suitably provides a calendaring of the days and weeks and months of a calendar year. Furthermore, the main or front cover of a calendar produced by the method of the invention can be provided in various forms, as can the register calendaring the months of the selected calendar year. Other similar types of calendars that may be produced according to the methodology specified in this disclosure can include computerized systems if so desired. Furthermore, rather than awarding prizes to the contestants, the prizes may each go to or otherwise be awarded to a selected charity designated by the service provider, or the winning contestant. Proceeds of the sale of calendars formed according to the principle of the invention may also go to or be awarded to one or more selected charities, foundations, schools, museums, etc.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A method of producing a calendar of a calendar year, comprising:
providing a photo contest having an entry period of time;
accepting photographs entered into the photo contest by contestants during the entry period of time to establish a pool of photographs to be judged, the photographs each relating to a contestant;
judging the photographs of the pool of photographs to produce photo contest winners comprising a calendar year photograph cover winner, and calendar month photograph cover winners; and
providing a calendar including a calendar cover and a register of calendar days of calendar weeks of calendar months of a calendar year, the calendar cover incorporating the calendar year photograph cover winner, and the register incorporating the calendar month photograph cover winners each relating to one of the calendar months.

2. The method according to claim 1, further comprising:
providing a grand prize having a first value; and
awarding the grand prize to the contestant relating to the calendar year photograph cover winner.

3. The method according to claim 2, further comprising:
providing monthly prizes each having a second value lesser than the first value of the grand prize; and
awarding one of the monthly prizes to each of the contestants relating to the calendar month photograph cover winners.

4. The method according to claim 3, further comprising:
the step of judging the photographs further comprises judging the photographs of the pool of photographs to produce runner-up calendar month photograph winners; and
the step of providing a calendar further includes providing the register incorporating at least one of the runner-up calendar month photograph winners with each of the calendar months.

5. The method according to claim 4, further comprising:
providing monthly runner-up prizes each having a third value lesser than the second value of each of the monthly prizes; and
awarding one of the monthly runner-up prizes to each of the contestants relating to the runner-up calendar month photograph winners.

6. The method according to claim 4, further comprising:
providing the calendar month photograph cover winners in a first size; and
providing the runner-up calendar month photograph winners each in a second size lesser than the first size.

7. The method according to claim 1, further comprising:
selling the advertising space to advertisers;
incorporating advertising space in the calendar;
incorporating advertisements of the advertisers in the advertising space.

8. The method according to claim 1, wherein the calendar further comprises a printed calendar.

9. A method of producing a calendar of a calendar year, comprising:
a service provider issuing purchase receipts to customers, the purchase receipts each providing in writing an acknowledgement of a customer payment of a bill and a photo contest entry form to be filled out with identifying information;
providing a photo contest having an entry period of time;
accepting photographs entered into the photo contest by contestants during the entry period of time to establish a pool of photographs to be judged, the photographs each relating to a contestant and attached to one of the purchase receipts issued by the service provider with the photo contest entry form thereof filled out in writing with identifying information relating to the contestant;
judging the photographs of the pool of photographs to produce photo contest winners comprising a calendar year photograph cover winner, and calendar month photograph cover winners; and
providing a calendar including a calendar cover and a register of calendar days of calendar weeks of calendar months of a calendar year, the calendar cover incorporating the calendar year photograph cover winner, and the register incorporating the calendar month photograph cover winners each relating to one of the calendar months.

10. The method according to claim 9, further comprising:
providing a grand prize having a first value;
using the identifying information of the purchase receipt attached to the calendar year photograph cover winner to identify the contestant relating thereto; and
awarding the grand prize to the contestant identified by the identifying information of the purchase receipt attached to the calendar year photograph cover winner.

11. The method according to claim 10, further comprising:
providing monthly prizes each having a second value lesser than the first value of the grand prize;
using the identifying information of the purchase receipts attached to the calendar month photograph cover winners to identify the contestants relating thereto; and
awarding one of the monthly prizes to each of the contestants relating to the calendar month photograph cover winners.

12. The method according to claim 9, further comprising:
selling the advertising space to advertisers;
incorporating advertising space in the calendar;
incorporating advertisements of the advertisers in the advertising space.

13. The method according to claim 9, wherein the calendar further comprises a printed calendar.

14. A method of producing a calendar of a calendar year, comprising:
a service provider issuing purchase receipts to customers, the purchase receipts each providing in writing an acknowledgement of a customer payment of a bill and a photo contest entry form to be filled out with identifying information;
providing a photo contest having an entry period of time;
accepting photographs entered into the photo contest by contestants during the entry period of time to establish a pool of photographs to be judged, the photographs each relating to a contestant and attached to one of the purchase receipts issued by the service provider with the photo contest entry form relating thereto filled out in writing with identifying information relating to the contestant;
judging the photographs of the pool of photographs to produce photo contest winners comprising a calendar year photograph cover winner, calendar month photograph cover winners, and runner-up calendar month photograph winners; and
providing a calendar including a calendar cover and a register of calendar days of calendar weeks of calendar months of a calendar year, the calendar cover incorporating the calendar year photograph cover winner, the register incorporating the calendar month photograph cover winners each relating to one of the calendar months, and each of the calendar months incorporating at least one of the runner-up calendar month photograph winners.

15. The method according to claim 14, further comprising:
providing the calendar month photograph cover winners in a first size; and
providing the runner-up calendar month photograph winners each in a second size lesser than the first size.

16. The method according to claim 14, further comprising:
providing a grand prize having a first value;
using the identifying information of the purchase receipt attached to the calendar year photograph cover winner to identify the contestant relating thereto; and
awarding the grand prize to the contestant identified by the identifying information of the purchase receipt attached to the calendar year photograph cover winner.

17. The method according to claim 16, further comprising:
providing monthly prizes each having a second value lesser than the first value of the grand prize;
using the identifying information of the purchase receipts attached to the calendar month photograph cover winners to identify the contestants relating thereto; and
awarding one of the monthly prizes to each of the contestants relating to the calendar month photograph cover winners.

18. The method according to claim 17, further comprising:
providing monthly runner-up prizes each having a third value lesser than the second value of each of the monthly prizes;
using the identifying information of the purchase receipts attached to the runner-up calendar month photograph winners to identify the contestants relating thereto; and
awarding one of the monthly runner-up prizes to each of the contestants relating to the runner-up calendar month photograph winners.

19. The method according to claim 14, further comprising:
selling the advertising space to advertisers;
incorporating advertising space in the calendar;
incorporating advertisements of the advertisers in the advertising space.

20. The method according to claim 14, wherein the calendar further comprises a printed calendar.
